(19) United States
(12) Patent Application Publication
(10) Pub. No.: US 2026/0255149 A1
(43) Pub. Date: Aug. 27, 2026

(54) STREAM CLASSIFICATION SERVICE RESOURCE RESERVATION AND NEGOTIATION FOR SEAMLESS ROAMING

(71) Applicant: Cisco Technology, Inc., San Jose, CA (US)

(72) Inventors: Binita GUPTA, San Diego, CA (US); Brian D. HART, Sunnyvale, CA (US); Malcolm M. SMITH, Richardson, TX (US)

(21) Appl. No.: 19/548,359

(22) Filed: Feb. 24, 2026

Related U.S. Application Data
(60) Provisional application No. 63/894,547, filed on Oct. 6, 2025.
(60) Provisional application No. 63/762,693, filed on Feb. 25, 2025.

(51) Int. Cl. H04W 8/14

(52) U.S. Cl. CPC H04W 8/14

(57) ABSTRACT

The present disclosure provides a method for stream classification service (SCS) resource reservation and renegotiation or negotiation for seamless roaming, including receiving, by a serving access point multi-link device (AP MLD) from a station multi-link device (STA MLD) connected with the serving AP MLD, a roaming preparation request identifying a plurality of stream classification service (SCS) streams of the STA MLD, forwarding, by the serving AP MLD, SCS-related information corresponding to one or more SCS streams, among the plurality of SCS streams, to a target AP MLD as part of a roaming preparation procedure, receiving, by the serving AP MLD from the target AP MLD, reservation status information indicating whether resources have been reserved for the one or more SCS streams forwarded by the serving AP MLD, and transmitting, by the serving AP MLD to the STA MLD, a roaming preparation response comprising the reservation status information.

### CROSS-REFERENCE TO RELATED APPLICATIONS

This application claims benefit of co-pending United States provisional patent application Serial No. 63/762,693 filed February 25, 2025 and co-pending United States provisional patent application Serial No. 63/894,547 filed October 6, 2025. The aforementioned related patent applications are herein incorporated by reference in their entirety.

### TECHNICAL FIELD

Embodiments presented in this disclosure generally relate to wireless communication. More specifically, embodiments disclosed herein relate to stream classification service (SCS) resource reservation and negotiation for seamless roaming.

### BACKGROUND

Wireless local area networks (WLANs) supporting seamless roaming enable a client device to switch between access points (APs) with reduced disruption to ongoing traffic flows. In multi-link wireless environments, seamless roaming is managed within a seamless mobility domain (SMD), where a serving AP coordinates mobility-related procedures with one or more candidate target APs prior to roaming. To maintain quality of service (QoS) for latency-sensitive traffic, such roaming procedures may initiate preparation at a target AP multi-link device (AP MLD), including assessment of available resources and consideration of stream classification service (SCS) requirements associated with the client device.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless communication environment for seamless roaming, according to some embodiments of the present disclosure.

FIG. 2 depicts an example roaming preparation signaling workflow, according to some embodiments of the present disclosure.

FIG. 3 depicts an example structure of a stream classification service (SCS) resource reservation configuration information included within a roaming preparation request, according to some embodiments of the present disclosure.

FIG. 4A depicts an example structure of an SCS resource reservation status information included within a roaming preparation response, according to some embodiments of the present disclosure.

FIG. 4B depicts an example structure of an SCS resource reservation status information included within a roaming preparation response, according to some embodiments of the present disclosure.

FIG. 5A depicts an example structure of an SCS context transfer configuration information included within a roaming preparation request, according to some embodiments of the present disclosure.

FIG. 5B depicts an example structure of an SCS context renegotiation or setup configuration information included within a roaming preparation request, according to some embodiments of the present disclosure.

FIG. 6A depicts an example structure of an SCS context renegotiation or setup status information included within a roaming preparation response, according to some embodiments of the present disclosure.

FIG. 6B depicts an example structure of an SCS context renegotiation or setup status information included within a roaming preparation response, according to some embodiments of the present disclosure.

FIG. 7 depicts an example method performed by a serving access point multi-link device (AP MLD) for roaming preparation, according to some embodiments of the present disclosure.

FIG. 8 depicts an example method performed by a station multi-link device (STA MLD) for roaming reparation, according to some embodiments of the present disclosure.

FIG. 9 depicts an example method performed by a target AP MLD for roaming preparation, according to some embodiments of the present disclosure.

FIG. 10 is a block diagram depicting an example roaming preparation method, according to some embodiments of the present disclosure.

FIG. 11 is a block diagram depicting an example roaming preparation method, according to some embodiments of the present disclosure.

FIG. 12 depicts an example STA MLD configured to perform various aspects of the present disclosure, according to some embodiments of the present disclosure.

FIG. 13 depicts an example AP MLD configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

One embodiment presented in this disclosure provides a method, including receiving, by a serving access point multi-link device (AP MLD) from a station multi-link device (STA MLD) connected with the serving AP MLD, a roaming preparation request identifying a plurality of stream classification service (SCS) streams of the STA MLD, forwarding, by the serving AP MLD, SCS-related information corresponding to one or more SCS streams, among the plurality of SCS streams to a target AP MLD as part of a roaming preparation procedure, receiving, by the serving AP MLD from the target AP MLD, reservation status information indicating whether resources have been reserved for the one or more SCS streams forwarded by the serving AP MLD, and transmitting, by the serving AP MLD to the STA MLD, a roaming preparation response comprising the reservation status information.

One embodiment presented in this disclosure provides a method, including transmitting, by a station multi-link device (STA MLD), a roaming preparation request to an access point multi-link device (AP MLD), the roaming preparation request comprising a plurality of stream classification service (SCS) streams of the STA MLD, receiving, by the STA MLD, a roaming preparation response from the AP MLD, the roaming preparation response comprising reservation status information indicating whether resources have been reserved at a target AP MLD for a first set of SCS streams, and performing, by the STA MLD, a roaming transition to the target AP MLD based at least in part on the reservation status information.

Other embodiments in this disclosure provide a computer program product comprising one or more computer-readable storage media collectively containing computer-readable program code that, when executed by operation of one or more computer processors, perform operations in accordance with one or more of the above methods, and a system of a network device comprising one or more computer processors, and one or more memories collectively containing one or more programs, which, when executed by the one or more computer processors, perform operations in accordance with one or more of the above methods.

### EXAMPLE EMBODIMENTS

Seamless roaming allows a wireless client device to switch between APs with reduced disruption to ongoing traffic flows. In multi-link wireless systems, such roaming is generally managed within a seamless mobility domain (SMD), where a serving access point multi-link device (AP MLD) (also referred to in some embodiments as the current AP MLD) coordinates roaming procedures with one or more candidate target APs prior to a roaming transition. As wireless applications increasingly rely on latency-sensitive and quality-of-service (QoS)-dependent traffic, roaming preparation procedures may involve coordination between serving AP MLD and one or more target AP MLDs, including evaluation of resource availability and consideration of stream classification service (SCS) requirements associated with the client device for reserving resources at the one or more target AP MLDs.

As disclosed herein, roaming preparation prior to roaming transition (also referred to in some embodiments as roaming execution) may include reservation of resources at a target AP multi-link device (AP MLD) and negotiation of SCS parameters so that traffic characteristics supported at a serving AP MLD can be maintained after roaming. Without such preparation, differences in resource availability, scheduling behavior, or SCS configurations at the target AP MLD may result in degraded service or interruption following the roaming transition.

Embodiments of the present disclosure provide methods, systems, and apparatuses for performing SCS resource reservation and SCS context negotiation for seamless roaming between a non-AP MLD (also referred to as a station multi-link device (STA MLD)) and one or more target AP MLDs. In some embodiments, roaming preparation is initiated by a STA MLD via a serving AP MLD, which coordinates with one or more candidate target AP MLDs to prepare resources and SCS context prior to completion of roaming. In such embodiments, the serving AP MLD acts as an intermediary between the STA MLD and the target AP MLD during the roaming preparation procedure.

In some embodiments, roaming information is exchanged directly between the STA MLD and a target AP MLD, without involvement of a serving AP MLD. In these configurations, similar logic to that as described below for reserving resources for the SCS streams at a target AP MLD during roaming may be applied between the STA MLD and the target AP MLD. For example, the STA MLD may identify a set of SCS streams in a roaming request transmitted directly to the target AP MLD, and the target AP MLD may prioritize SCS resource reservation for the identified set of SCS streams and indicate, in a corresponding roaming response, for which SCS stream resources have been reserved to the STA MLD. In these embodiments, the STA MLD may also indicate request for renegotiation or negotiation (or setup) for new SCS streams with the target AP MLD in the roaming request sent directly to the target AP MLD, and the target AP MLD then indicates in the roaming response whether SCS stream renegotiation or negotiation is accepted or not. The roaming request sent directly to the target AP MLD may be a roaming execution request that initiates a roaming transition (after roaming preparation has been performed via the serving AP MLD) or may be a direct roaming request sent without prior roaming preparation with the serving AP MLD. In one embodiment, a STA MLD transmits a roaming preparation request identifying a plurality of SCS streams associated with the STA MLD. The roaming preparation request is received by a serving AP MLD and forwarded to one or more target AP MLDs for evaluation. A separate roaming preparation request may be sent by the STA MLD to the serving AP MLD for each candidate target AP MLD, which is then forwarded to the respective target AP MLD. The serving AP MLD may adjust or reformat the roaming preparation request before forwarding it to a target AP MLD, where the forwarded request includes the information for the one or more SCS streams of the STA MLD based on the roaming preparation request. Each target AP MLD evaluates available resources and determines whether resources can be reserved for one or more of the SCS streams. Reservation result information is returned to the serving AP MLD and included in a roaming preparation response transmitted to the STA MLD prior to the roaming transition.

In one embodiment related to SCS resource reservation, a target AP MLD reserves resources for all requested SCS streams or for a subset of the requested SCS streams when resources are constrained. In one embodiment, in the roaming preparation request, the STA MLD indicates that roaming preparation is to be completed only if resources for specified SCS streams can be reserved at the target AP MLD. In one embodiment, in the roaming preparation request, the STA MLD provides information identifying a list of preferred SCS streams (e.g., using a list of one or more SCS identifiers (SCS IDs)) that could be prioritized for resource reservation at the target AP MLD. In this embodiment, the target AP MLD prioritizes the list of identified SCS streams in its SCS resource allocation for the STA MLD during the roaming preparation procedure. If roaming is performed by sending a roaming request directly to the target AP MLD, the list of preferred SCS streams may be indicated in the roaming request sent directly to the target AP MLD, and the target AP MLD prioritizes those SCS streams in its SCS resource allocation.

In one embodiment, the target AP MLD indicates to the serving AP MLD which of the SCS streams have been accepted at the target AP MLD for the STA MLD. This information may be provided to the serving AP MLD when (i) the STA MLD includes a list of preferred SCS streams in the roaming preparation request, or (ii) the STA MLD does not include a list of preferred SCS streams in the roaming preparation request. The serving AP MLD provides the list of SCS streams that are accepted by the target AP MLD in the roaming preparation response sent to the STA MLD. If roaming is performed by sending a roaming request directly to the target AP MLD, then the target AP MLD indicates in the roaming response directly sent to the STA MLD which of the SCS streams have been accepted at the target AP MLD.

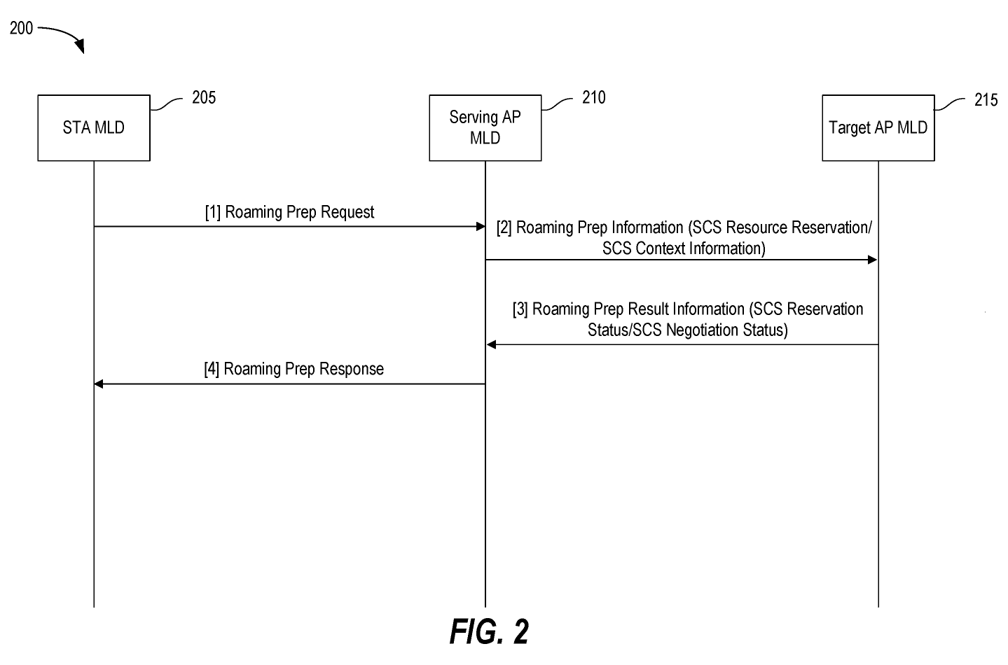

In one embodiment, for accepted SCS streams by the target AP MLD as part of the roaming preparation procedure, the target AP MLD provides information for aligning service start times of the SCS streams to the timing reference of the target AP MLD, including direct service start time signaling or link-based time offset signaling. In the embodiment of direct service start time signaling, the target AP MLD provides the adjusted service start time for each of the accepted SCS streams in the roaming preparation response as described below with reference to FIG. 2. In the link-based time offset signaling, the target AP MLD provides a time offset (also referred to in some embodiments as the timing synchronization function (TSF) offset) to be applied to the service start time for each of the accepted SCS streams in the roaming preparation response as described below with reference to FIG. 2.

In one embodiment, SCS context (which includes information in the SCS descriptor element) for SCS streams of the STA MLD for which resources could not be reserved at the target AP MLD are still transferred to the target AP MLD, although quality of service (QoS) requirements associated with those SCS streams may not be met (or only partially met) after roaming.

The reservation status information indicating whether resources are reserved for all, a subset, or none of the SCS streams at the target AP MLD is provided to the STA MLD as part of the roaming preparation response, or in a roaming response directly transmitted by the target AP MLD to the STA MLD, if roaming is performed directly with the target AP MLD as described above.

In one embodiment related to SCS context renegotiation, the serving AP MLD transfers SCS context information for all SCS streams that are established/setup for a STA MLD to a target AP MLD without performing any renegotiation for any of those SCS streams or setup/negotiation of any new SCS streams during roaming preparation. Such an approach does not allow any SCS stream negotiation as part of the roaming preparation procedure. The renegotiation for certain SCS streams and negotiation for any new SCS stream may be initiated after the roaming transition is completed. In one embodiment, SCS stream renegotiation and negotiation/setup of new SCS streams is allowed (or desired) as part of the roaming preparation procedure. The STA MLD controls which SCS streams are transferred during roaming preparation and may request renegotiation of SCS parameters for certain (already established) SCS streams or request negotiation/setup of new SCS streams with the target AP MLD during roaming preparation. In such cases, the target AP MLD provides per-SCS stream status information indicating acceptance or rejection of the requested SCS streams and may include suggested SCS parameters for rejected SCS streams as part of the roaming preparation response. The renegotiation of an SCS stream with the target AP MLD may involve a STA MLD indicating revised SCS parameters (e.g., in an SCS descriptor element) for that SCS stream (identified by the SCSID) in the roaming preparation request, the serving AP MLD forwarding the revised SCS parameters to the target AP MLD, the target AP MLD determining whether the SCS parameters can be accepted or not, and then providing the status response (e.g., accept or reject) for the SCS stream to the STA MLD in the roaming preparation response. In one embodiment, if the target AP MLD cannot accept the revised SCS parameters but can accept the old SCS parameters for that SCS stream, then the SCS stream is setup/established at the target AP MLD with the old (or already setup) set of SCS parameters, and this is indicated to the STA MLD. As used herein, the old SCS parameters refer to a set of SCS parameters that were previously established between a STA MLD and a serving AP MLD prior to initiation of a roaming preparation procedure. In this embodiment, the serving AP MLD forwards both the old SCS parameters and the revised SCS parameters for the SCS stream to the target AP MLD. In another embodiment, if the target AP MLD cannot accept the revised SCS parameters for an SCS stream, then the SCS stream is not setup at the target AP MLD, and a reject response is indicated to the STA MLD for that SCS stream. In one embodiment, this renegotiation of the SCS stream can also be performed in the roaming request/response exchange performed directly with the target AP MLD (as described above), where the STA MLD indicates renegotiation for an SCS stream in the roaming request sent to the target AP MLD (along with revised SCS parameters), and the target AP MLD may indicate accept or reject status for the SCS renegotiation in the roaming response it sends to the STA MLD.

In some embodiments, the negotiation/setup of a new SCS stream with the target AP MLD during roaming procedure involves a STA MLD indicating request for setting up a new SCS stream, for example, by including an SCS descriptor element specifying the parameters for the SCS stream including the SCSID, in the roaming preparation request, the serving AP MLD forwarding the request for new SCS stream setup to the target AP MLD (including SCS parameters in the SCS descriptor element), the target AP MLD determining whether the new SCS stream (based on the received SCS parameters) can be accepted or not and providing the status response (e.g., accept or reject) for the new SCS stream to the STA MLD in the roaming preparation response. In one embodiment, this negotiation/setup of a new SCS stream at the target AP MLD can also be performed in the roaming request/response exchange performed directly with the target AP MLD (as described above), where the STA MLD indicates negotiation/setup for a new SCS stream in the roaming request sent to the target AP MLD (along with the SCS parameters for the new SCS stream), and the target AP MLD may indicate accept or reject status for the new SCS stream in the roaming response it sends to the STA MLD. The disclosed embodiments provide mechanisms for SCS resource reservation, timing alignment, SCS renegotiation, SCS negotiation/setup, and overall SCS context handling during seamless roaming. The disclosed approaches allow roaming decisions to be informed by anticipated support of SCS streams at a target AP MLD and reduce disruption to SCS traffic during mobility events.

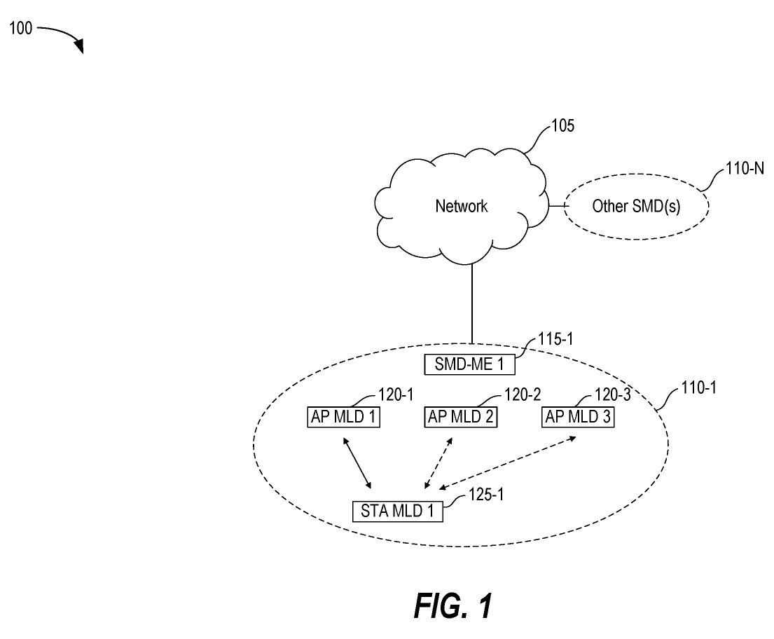

FIG. 1 depicts an example wireless communication environment 100 where seamless roaming may be performed within a seamless mobility domain (SMD), according to some embodiment of the present disclosure.

As depicted, a network 105 is connected to a first SMD 110-1 and to one or more other SMD(s) 110-N. The network 105 may include one or more wired or wireless networks, such as a local area network, a wide area network, or a core network, and provide connectivity between SMDs 110 or to external systems.

Within the SMD 110-1, a mobility management entity, also referred to as an SMD management entity (SMD-ME) 115-1, is configured to support mobility-related coordination among AP MLDs within the SMD. The SMD 110-1 further includes a plurality of access point multi-link devices (AP MLDs), including AP MLD 1 (120-1), AP MLD 2 (120-2), and AP MLD 3 (120-3). Each AP MLD may provide multi-link wireless connectivity to client devices and may communicate with other AP MLDs within the SMD 110-1 via an inter-AP communication path (e.g., a backhaul network).

As depicted, a non-AP multi-link device (also referred to as a station multi-link device (STA MLD)) 125-1 is located within the coverage area of the SMD 110-1. In the illustrated example, STA MLD 1 (125-1) is associated with the SMD-ME and currently connected with AP MLD 1 (120-1). The AP MLD 1 (120-1) therefore operates as a serving AP MLD (also referred to in some embodiments as the current AP MLD) for the STA MLD 1 (125-1). AP MLD 2 (120-2) and AP MLD 3 (120-3) are additional AP MLDs within the same SMD and represent candidate target AP MLDs to which the STA MLD 1 (125-1) may roam.

During operation, when STA MLD 1 (125-1) determines that a roaming transition within the SMD 110-1 may occur, a roaming preparation procedure is initiated prior to the start of the roaming transition (also referred to in some embodiments as the roaming execution). In one embodiment, the roaming preparation is initiated by STA MLD 1 (125-1) via the serving AP MLD, which is AP MLD 1 (120-1). The AP MLD 1 (120-1) coordinates roaming preparation with one or more candidate target AP MLDs, such as AP MLD 2 (120-2) and AP MLD 3 (120-3), to evaluate resource availability for SCS streams at the candidate target AP MLDs prior to roaming. In this configuration, STA MLD 1 (125-1) provides roaming preparation information to the serving AP MLD (AP MLD 1 (120-1)), including information identifying SCS streams associated with the STA MLD 1 (125-1). In some embodiments, the roaming preparation information is provided via a roaming preparation request. The serving AP MLD then forwards corresponding roaming preparation information to one or more of the AP MLD 2 (120-2) and AP MLD 3 (120-3) via inter-AP communication paths within the SMD 110-1. Each of the candidate target AP MLDs evaluates its available resources and determines whether resources can be reserved for one or more of the identified SCS streams. Each target AP MLD then returns roaming preparation result information to the serving AP MLD, including status information for resource reservation for the identified SCS streams.

Based on the roaming preparation result information received from AP MLD 2 (120-2) and AP MLD 3 (120-3), the AP MLD 1 (120-1) provides a roaming preparation response to the STA MLD 1 (125-1). The roaming preparation response may indicate reservation status information for SCS streams at one or more candidate target AP MLDs. The response allows the STA MLD 1 (125-1) to make an informed roaming decision within the SMD 110-1. In one embodiment, the roaming preparation request/response exchange is performed for one candidate target AP MLD at a time, where the roaming preparation request indicates a single candidate target AP MLD and SCS streams reservation on that target AP MLD. The serving AP MLD forwards information to the single target AP MLD identified in the roaming preparation request, and the target AP MLD evaluates its available resources and determines whether resources can be reserved for one or more of the identified SCS streams. The target AP MLD then indicates the status information for resource reservation for the identified SCS streams to the serving AP MLD. Based on the shared information, the serving AP MLD provides reservation status information for SCS streams at the target AP MLD in the roaming preparation response sent to the STA MLD.

Although FIG. 1 depicts roaming preparation coordinated by a serving AP MLD, in some embodiments, roaming preparation information may be exchanged directly between a STA MLD (e.g., STA MLD 1 (125-1)) and a target AP MLD (e.g., AP MLD 2 (120-2)), or may involve additional entities within or outside of the SMD (e.g., SMD-ME 1 (115-1)). More details about the roaming preparation procedures are discussed below with reference to FIGS. 2-5.

FIG. 2 depicts an example roaming preparation signaling workflow among a STA MLD 205, a serving AP MLD 210, and one or more target AP MLD(s) 215. The STA MLD 205 may correspond to STA MLD 1 (125-1) as depicted in FIG. 1, the serving AP MLD 210 may correspond to AP MLD 1 (120-1) in FIG. 1, and the target AP MLD 215 may correspond to one of AP MLD 2 (120-2) and AP MLD 3 (120-3) in FIG. 1. Although a single target AP MLD 215 is illustrated for conceptual clarity, roaming preparation may be performed with multiple candidate target AP MLDs in parallel or sequentially.

As depicted, roaming preparation includes four steps. As used herein, roaming preparation refers to a pre-roaming process, where information is exchanged to evaluate resource availability for SCS streams at candidate target AP MLDs. In step 1, STA MLD 205 transmits a roaming preparation request to serving AP MLD 210. In step 2, serving AP MLD 210 forwards roaming preparation information to target AP MLD 215. In step 3, target AP MLD 215 returns roaming preparation result information to serving AP MLD 210. In step 4, serving AP MLD 210 transmits a roaming preparation response to STA MLD 205.

In the illustrated embodiment, the roaming preparation request and roaming preparation response exchanged between STA MLD 205 and serving AP MLD 210 are transmitted over the air (OTA). The roaming preparation information and roaming preparation result information exchanged between serving AP MLD 210 and target AP MLD 215 may be transmitted via an inter-AP communication path, such as a backhaul network (wired or wireless), a wired network, or another communication interface between AP MLDs.

In some embodiments, roaming preparation information may be exchanged directly between STA MLD 205 and one or more target AP MLDs 215. In such embodiments, STA MLD 205 may transmit a roaming preparation request (or another roaming request) directly to one or more target AP MLDs 215 and receive a roaming preparation response (or another roaming response) directly from the target AP MLDs 215. The direct communication may be used, for example, when STA MLD 205 does not have reliable links with the serving AP MLD. In some embodiments, roaming preparation may be coordinated via an additional entity within or outside of the SMD, such as the SMD-ME (e.g., SMD-ME 1 (115-1) in FIG. 1) or a wireless controller, which facilitates the exchange of roaming preparation information between the STA MLD and one or more target AP MLDs.

The roaming preparation request transmitted in step 1 may include information identifying SCS streams associated with STA MLD 205. In some embodiments, the roaming preparation request includes an indicator that resource reservation is requested for all SCS streams of the STA MLD 205. In some embodiments, the roaming preparation request includes a list of one or more SCS streams (identified by the SCS identifiers (SCS IDs)) indicating SCS streams associated with the STA MLD 205 for which resource reservation is requested to be prioritized at the target AP MLD. For example, the request may include a field indicating a count/number of SCS identifiers (SCS IDs) and a field including a list of SCS IDs corresponding to a plurality of SCS streams associated with the STA MLD 205 for which resource reservation is requested to be prioritized at the target AP MLD.

In some embodiments, the roaming preparation request further includes an indication that roaming preparation with a target AP MLD is to be completed only if resources for all SCS streams, or for specified SCS streams (in the roaming preparation request), can be reserved at the target AP MLD 215. In some embodiments, the roaming preparation request may include information identifying one or more SCS streams that are to be prioritized for SCS resource reservation at the target AP MLD when resources at the target AP MLD 215 are limited.

In some embodiments, SCS context renegotiation is not allowed as part of the roaming preparation procedure. In such cases, renegotiation of one or more SCS streams may be conducted after roaming is completed. For these embodiments, the roaming preparation request may include information identifying all SCS streams associated with the STA MLD 205 (or may not include information for SCS streams, where all SCS streams, by default, are considered for reserving resources at the target AP MLD), and the serving AP MLD 210 forwards corresponding SCS information to the target AP MLD 215 (e.g., forwards SCS context information for all SCS streams of the STA MLD). In one embodiment, when STA MLD does not have any preference for prioritizing resource reservation for SCS streams at the target AP MLD, then it may not include any SCS streams in the roaming preparation request, where, as described above, all SCS streams are considered for reserving resources at the target AP MLD. The target AP MLD 215 evaluates available resources and may reserve resources for all of the forwarded SCS streams or for a subset of the forwarded SCS streams when resources are limited (e.g., based on priority information associated with the SCS streams). For SCS streams for which resources are not reserved, SCS session information may still be transferred to the target AP MLD 215. The target AP MLD 215 may not be able to meet the QoS requirements associated with those SCS streams after the roaming transition.

In some embodiments, the network may have some policies or rules applied to prioritize resource reservation for SCS streams at the target AP MLD (e.g., prioritize resource reservation for SCS flows that are important for the given deployment). Then target AP MLD accounts for the network side policy and/or the request from the STA MLD when prioritizing resource reservation for SCS streams at the target AP MLD. The target AP MLD may give higher importance to the AP side policy or STA side request or consider them equally when performing resource reservation for SCS streams.

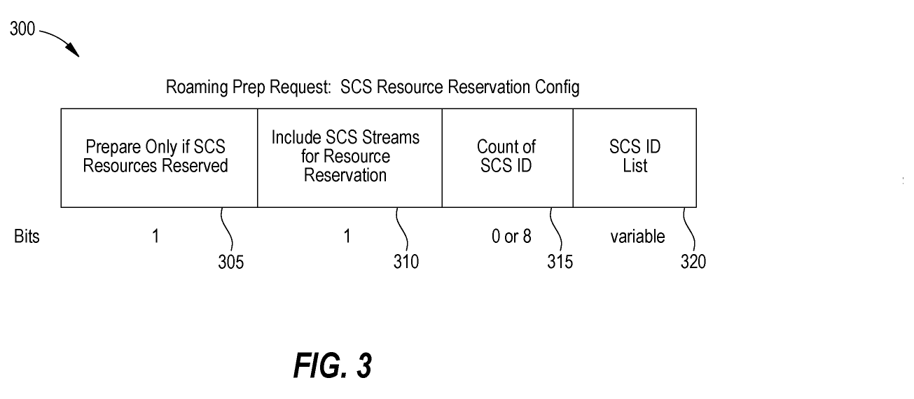

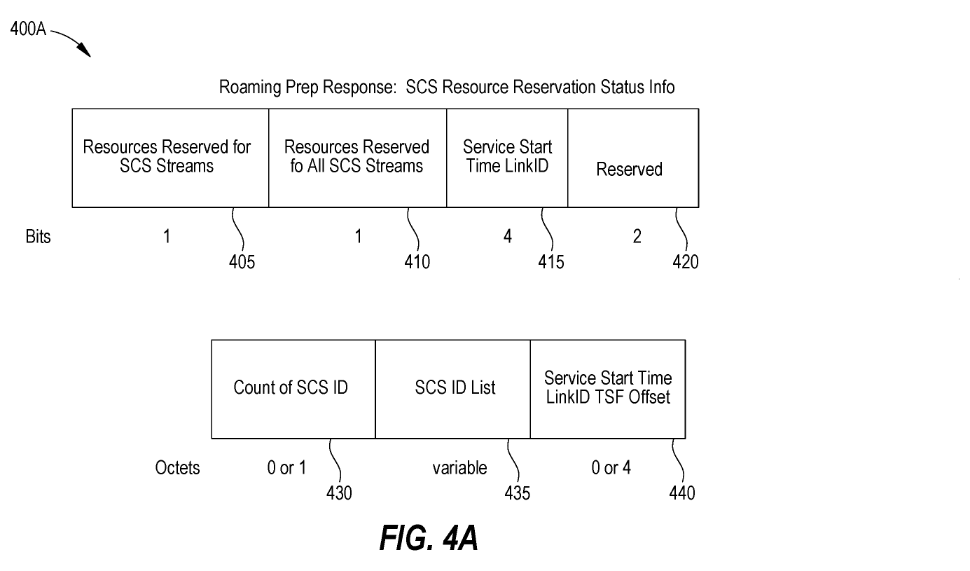

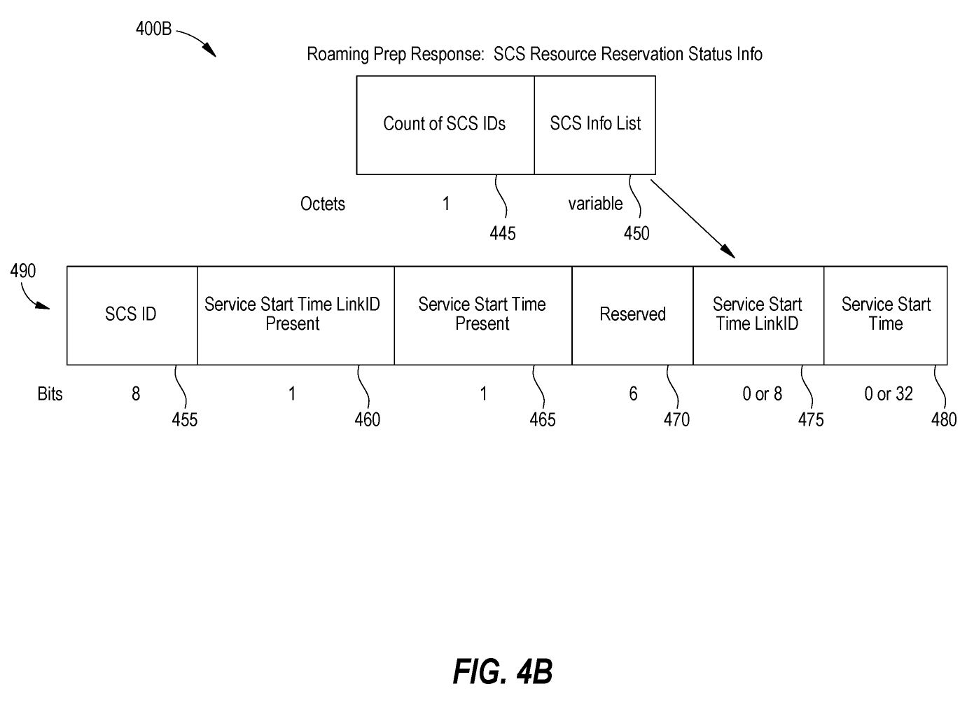

In embodiments where SCS context renegotiation is supported during roaming preparation, the roaming preparation request in step 1 may include information identifying SCS streams that are not to be transferred to the target AP MLDs, such as SCS streams that are no longer active or that are to be renegotiated (e.g., due to changes in traffic pattern). In some embodiments, the roaming preparation request may indicate that one or more SCS streams are to be renegotiated with the target AP MLD 215, for example, by including one or more SCS descriptor elements carrying revised SCS parameters corresponding to the SCS streams to be renegotiated. In one embodiment, if an SCS stream (identified by the SCS ID) is indicated for renegotiation with the target AP MLD, then the old set of SCS parameters for that SCS stream is not transferred to the target AP MLD, and only a revised set of SCS parameters is provided to the target AP MLD (e.g., as part of an SCS descriptor element). In some embodiments, where negotiation or setup of new SCS streams with the target AP MLD is supported during roaming preparation, the roaming preparation request in step 1 may include information identifying one or more new SCS streams for negotiation (or setup) with the target AP MLD. This can be achieved by including an SCS descriptor element (specifying the SCS parameters including the SCSID) for each new SCS stream. Additional details regarding example formats and contents of the roaming preparation request are discussed below with reference to FIGS. 3-4.

In step 2, as depicted, serving AP MLD 210 forwards roaming preparation information corresponding to one or more of the SCS streams indicated by STA MLD 205 to target AP MLD 215. The forwarded SCS streams include one or more of the SCS streams that are already setup with the serving AP MLD, the SCS streams that are setup with the serving AP MLD but are requested to be renegotiated with the target AP MLD, or the new SCS streams that are requested to be negotiated or setup with the target AP MLD. Target AP MLD 215 evaluates available resources and determines whether resources can be reserved for one or more of the forwarded SCS streams received from the serving AP MLD. In step 3, target AP MLD 215 transmits roaming preparation result information to serving AP MLD, indicating reservation results for the forwarded SCS streams. In embodiments where SCS context renegotiation (for existing SCS streams) or negotiation (for new SCS streams) is allowed for one or more SCS streams, the roaming preparation result information may further include per-SCS stream negotiation status information indicating acceptance or rejection of requested SCS renegotiation or negotiation, and may optionally include suggested SCS parameters transmitted within one or more SCS descriptor elements for the streams that are rejected by the target AP MLD.

The roaming preparation response transmitted in step 4 may include reservation status information indicating whether resources have been reserved for one or more SCS streams at the target AP MLD. For example, the response can indicate whether resources have been reserved for all SCS streams associated with the STA MLD, or for all forwarded SCS streams of the STA MLD, or a subset of the forwarded SCS streams of the STA MLD, or any subset of SCS streams of the STA MLD, or none of the forwarded SCS streams, or none of the SCS streams of the STA MLD at target AP MLD 215. The roaming preparation response may further include revised service start time information for accepted SCS streams to align timing references used for service start time between serving and target AP MLDs. In one embodiment, for each of the accepted SCS streams, the roaming preparation response indicates the adjusted service start time (e.g., the adjusted value for the Service Start Time field), adjusted to the TSF of a reference link of the target AP MLD. The response also indicates the link of the target AP MLD, which is used as the reference link for the service start time for each of the SCS streams, where the same link of the target AP MLD could be used as a reference link for the service start time for all/multiple SCS streams, or different links could be used as reference links for the service start time for SCS streams. Thus, the roaming preparation response may indicate the service start time link ID (indicating the reference link) and the service start time for each of the accepted SCS streams. In some embodiments, for further optimization, when the service start time for each of the accepted SCS streams is indicated with regard to the same common reference link of the serving AP MLD, the roaming preparation response may include a single common time offset (e.g., TSF offset) that is to be applied for all accepted SCS streams, to adjust the service start time for the SCS streams based on the TSF of the target AP MLD. In other embodiments, when the service start time for each of the accepted SCS streams is indicated with regard to different reference links of the serving AP MLD, then the timing offset (e.g. TSF offset) to be applied will be different for each of the accepted SCS streams. In this case, a separate timing offset (TSF offset) may be provided for each of the accepted SCS streams. The service start time for each of the accepted SCS streams is adjusted for the target AP MLD based on the TSF offset indicated for the SCS stream. The reference link to be used for the service start time on the target AP MLD (e.g., the Service Start Time Link ID) could be the same link of the target AP MLD for all the accepted SCS streams or could be different links of the target AP MLD. In one embodiment, roaming preparation response indicates the link of the target AP MLD that is used as the reference link for the service start time for each of the accepted SCS streams. In some embodiments, timing/TSF offsets can be indicated for different link pairs of the serving AP MLD and the target AP MLD in the roaming preparation response. Then for an SCS stream based on the service start time reference link used at the serving AP MLD (e.g., the Service Start Time Link ID at the serving AP MLD) and the service start time reference link used at the target AP MLD (e.g., the Service Start Time Link ID at the target AP MLD), the serving start time value for the SCS stream is adjusted for the target AP MLD (both by the target AP MLD and the SAT MLD) based on the TSF offset indicated for that link pair.

In embodiments where SCS renegotiation/negotiation is permitted for one or more SCS streams, the roaming preparation response may further include per-SCS status information indicating acceptance or rejection of each SCS requested for renegotiation/negotiation at target AP MLD 215. For SCS streams that are rejected, the roaming preparation response may include one or more suggested SCS parameters conveyed in one or more SCS descriptor elements. In some embodiments, the accepted list of SCS streams indicated in the roaming preparation response also indicates the accepted SCS IDs for one or more SCS streams that are being renegotiated/negotiated with the target AP MLD (instead of indicating separate per-SCS status information for such SCS streams). Additional details regarding example formats and contents of the roaming preparation response are discussed below with reference to FIGS. 3-4.

FIG. 3 depicts an example structure 300 of a stream classification service (SCS) resource reservation configuration information included within a roaming preparation request, according to some embodiments of the present disclosure. This configuration information may be included as fields in an existing or new element in the roaming preparation request. As depicted, the SCS resource reservation configuration information includes a plurality of fields. Each field conveys control information associated with SCS resource reservation. The first field 305, also referred to as the Prepare Only If SCS Resource Reserved field, comprises a single bit that indicates whether the roaming preparation request is to be processed only if SCS resources have been successfully reserved on the target AP MLD. When set to a first value (e.g., “1”), this field 305 instructs a receiving entity, such as a candidate target AP MLD (e.g., 215 in FIG. 2), to proceed with roaming preparation only when resources can be reserved for all SCS streams requested by a STA MLD. When set to a second value (e.g., “0”), the roaming preparation request may proceed regardless of SCS resource reservation status, such as when only a subset of the requested SCS streams, or none of the requested SCS streams, can be reserved.

As shown, the SCS resource reservation configuration information may include a second field 310, also referred to as the Include SCS Streams for Resource Reservation field. The second field 310 comprises a single bit that indicates whether SCS streams are included for resource reservation. More specifically, this field provides a presence indication for the SCS streams. When set to a first value (e.g., “1”), the second field 310 indicates that the roaming preparation request includes one or more SCS streams (identified by the SCS IDs) for which prioritization of resource reservation is requested at the target AP MLD. When set to a second value (e.g., “0”), the second field 310 indicates that no SCS streams are included for which prioritization of resource reservation is requested as part of the roaming preparation request. In the latter case, resource reservation is requested for all SCS streams at the target AP MLD without any prioritization of resource reservation for specific SCS streams.

A third field 315 within the SCS resource reservation configuration, also referred to as the Count of SCS ID field, specifies a count of SCS identifiers (IDs) (or the number of SCS IDs) included in the request. In the illustrated embodiment, the count field may comprise a predefined number of bits, such as up to eight bits, indicating the number of SCS identifiers that follow. When the count field indicates zero, no SCS IDs are included. When the count field indicates a non-zero value, the configuration includes a corresponding number of SCS IDs.

A fourth field 320 within the configuration, also referred to as the SCS ID List field, comprises a variable-length list of SCS IDs. The number of entries in the SCS ID list corresponds to the value indicated by the third field 315. Each SCS ID in the list uniquely identifies an SCS stream for which prioritization of resource reservation is requested.

As illustrated, the SCS resource reservation configuration information is included within a roaming preparation request, such that a STA MLD (e.g., 205 in FIG. 2) transmits, to a serving AP MLD (e.g., 210 in FIG. 2), information identifying for which SCS streams prioritization of resource reservation is requested. In some embodiments, only a subset of the fields indicated in FIG. 3 may be included in the roaming preparation request. For example, the Prepare Only If SCS Resource Reserved field 305 may not be included. The serving AP forwards the roaming preparation information, including the SCS resource reservation configuration, to one or more candidate target AP MLDs (e.g., 215 in FIG. 2) to enable prioritization of resource reservation for SCS streams for roaming preparation . Based on the received configuration, the target AP MLD determines for which SCS streams prioritization of resource reservation is requested, and then the target AP MLD attempts to prioritize reserving resources first for those SCS streams.

In some embodiments, the target AP MLD performs roaming preparation even when it is unable to satisfy/reserve resources for all requested SCS streams in the SCS resource reservation configuration, unless the field 305 (if included) indicates that roaming preparation is to proceed only if resources can be reserved for all requested SCS streams. In one embodiment, for SCS streams for which resource requirements cannot be satisfied or resources could not be reserved on the target AP MLD, the SCS stream context may still be transferred to the target AP MLD, and the SCS stream may still be maintained by the target AP MLD. In this case, the list of SCS streams that are accepted but for which resources are not reserved at the target AP MLD can be indicated in the roaming preparation response. In this case, data transfer may still occur after roaming for that SCS stream. However, performance characteristics associated with those SCS streams are not guaranteed. In this manner, the configuration enables flexible roaming preparation behavior that supports both latency-sensitive and best-effort SCS handling depending on the indicated reservation policy.

FIG. 4A depicts an example structure 400A of an SCS resource reservation status information included within a roaming preparation response, according to some embodiments of the present disclosure. This information may be included as fields in an existing or new element in the roaming preparation response.

As shown, the example structure 400A includes a first field 405, also referred to as the Resource Reserved for SCS Streams field, which indicates whether resources have been reserved for one or more requested SCS streams. The structure 400A further includes a second field 410, also referred to as the Resources Reserved for All SCS Streams field, which indicates whether resources have been reserved for all requested SCS streams.

Each of the fields 405 and 410 may comprise a single bit indicating reservation status information to the requesting entity. For example, when the field 405 is set to a first value (e.g., “1”), it indicates that resources have been reserved for one or more requested SCS streams. When the field 405 is set to a second value (e.g., “0”), it indicates that no resources have been reserved for any of the requested SCS streams. The field 410 indicates whether resources have been reserved for all requested SCS streams. When the field 410 is set to a first value (e.g., “1”), it indicates that resources have been reserved for all requested SCS streams. When the field 410 is set to a second value (e.g., “0”), it indicates that resources have been reserved for only a subset of the requested SCS streams. By interpreting the fields 405 and 410 in combination, the receiving entity (e.g., the STA MLD 205 in FIG. 2) can determine whether resources have been reserved for all requested SCS streams, for a subset of the requested SCS streams, or for none of the requested SCS streams.

As depicted, the example structure 400A further includes a third field 415, also referred to as the Service Start Time LinkID field, which identifies a link of the target AP MLD that is used as a reference link for the service start time of the SCS streams accepted by the target AP MLD. In one embodiment, the field 415 includes a link ID indicating a specific link (e.g., a 2.4 GHz link, a 5 GHz link, or a 6 GHz link) of the target AP MLD used as a reference link for the service start time of accepted SCS streams .

The service start time for an SCS stream indicates the estimated start time when the traffic starts for that SCS stream. When all accepted SCS streams use the same reference link for their service start time at the target AP MLD, a single instance of the field 415 is included in the roaming preparation response. When all accepted SCS streams also have the same reference link at the serving AP MLD, then the service start time for each of the SCS streams can be adjusted by applying the time offset (e.g., a TSF offset) between the reference link used at the serving AP MLD and a common reference link used at the target AP MLD. In this case, a Service Start Time LinkID TSF Offset field 440 is included to provide this TSF offset, which is applied to the service start time for each accepted SCS stream to determine the revised TSF offset for the SCS stream for the target AP MLD. In one embodiment, the Service Start Time LinkID TSF Offset field 440 may be included separately for each accepted SCS stream (not shown in FIG. 4A), if the reference link of SCS streams at the serving AP MLD may be different. In another embodiment, the reference link used at the target AP MLD for service start time may be different for each accepted SCS stream, where a Service Start Time LinkID field 415 is indicated separately for each accepted SCS stream (not shown in FIG. 4A).

As illustrated, the example structure 400A further includes a Count of SCS ID field 430 and an SCS ID List field 435, which together identify the SCS streams that are accepted at the target AP MLD and for which resources are reserved. In the illustrated embodiment, the Count of SCS ID field 430 may comprise zero or one octet and indicates the number of SCS IDs included in the SCS ID list. The SCS ID List field 435 has a variable length corresponding to the value indicated by the Count of SCS ID field 430, and includes one or more SCS IDs identifying the SCS streams that are accepted at the target AP MLD. The response further comprises a Reserved field 420, which is included for alignment, padding, or future use. The Reserved field 420 is set to a predefined value (e.g., zero) and is ignored by a receiving entity. The Reserved field 420 may be used in future revisions to convey additional information without altering the overall structure of the response.

Through the illustrated example structure of the roaming preparation response, the target AP MLD (e.g., 215 in FIG. 2) provides to the STA MLD (e.g., 205 in FIG. 2) the status of SCS resource reservation at the target AP MLD, together with the associated service start timing information. In some embodiments, only a subset of fields indicated in FIG. 4A may be included in the roaming preparation response, for example, only fields related to providing an SCS ID list (e.g., fields 430 and 435) and fields related to service start time for SCS streams (e.g., fields 415 and 440) may be included.

FIG. 4B depicts another example structure 400B of an SCS resource reservation status information included within a roaming preparation response. The illustrated structure provides service start time-related information separately for each SCS stream.

As depicted, the example structure 400B includes a Count of SCS IDs field 445, which indicates the number/count of SCS streams for which resource reservation is requested. The Count of SCS IDs field 445 is equivalent to the Count of SCS ID field 430 shown in FIG. 4A. The structure 400B further includes an SCS Info List field 450, which comprises a plurality of fields (e.g., as indicated in 490), each corresponding to an SCS stream identified by the SCS ID. The SCS Info List field 450 includes one or more SCS Info fields 490 and has a variable length corresponding to the number of SCS streams indicated by field 445.

Each SCS Info field 490 includes an SCS ID field 455, which identifies an SCS stream that is accepted at the target AP MLD. The SCS Info field further includes a Service Start Time LinkID Present field 460 and a Service Start Time Present field 465, each of which may comprise a single bit indicating whether corresponding fields are present in the SCS Info field. For example, the Service Start Time LinkID Present field is set to “1” to indicate the presence of the Service Start Time LinkID field, and the Service Start Time Present field is set to “1” to indicate the presence of the Service Start Time field. A Reserved field 470 may be included for alignment or future use and is ignored by the receiving entity unless otherwise specified. In one embodiment, the Service Start Time LinkID field 465 may be a 4-bit field. In one embodiment, the size of the Service Start Time LinkID field 475 may be different than 32 bits.

When the presence is indicated by fields 460 and 465, the SCS Info 490 further includes a Service Start Time LinkID field 475 and a Service Start Time field 480, which together specify the adjusted service start time (adjusted for the target AP MLD) for the SCS stream indicated by the SCS ID.

In some embodiments, a common reference link of the target AP MLD is used for service start time for all accepted SCS streams, and per-link timing differences for service start time are indicated using TSF offsets. In such configurations, a single Service Start Time LinkID field 475 is provided in the roaming preparation response (outside the per SCS ID SCS Info field), which identifies a selected reference link at the target AP MLD for service start time for all accepted SCS streams. The service start time is still indicated per SCS stream in the SCS Info field 490, as indicated within the Service Start Time field 480. In some embodiments, the roaming preparation response may provide TSF offset information between setup links of the current AP MLD and the selected reference link at the target AP MLD. The TSF offset information may be conveyed as a series of tuples, such as <LinkID_x, TSF Offset for LinkID_x>, where LinkID_x identifies a link at the current AP MLD, and the TSF Offset for LinkID_x indicates a TSF offset between that link and the reference link selected at the target AP MLD for service start time of SCS streams. Using the information, the non-AP MLD can modify the service start time for each accepted SCS stream by applying the corresponding TSF offset. For example, if an SCS stream uses link 1 (e.g., a 2.4 GHz link) as a reference link at the current AP MLD, the non-AP MLD applies the TSF offset received for link 1 to the service start time for the SCS stream to obtain an adjusted service start time for that SCS stream, which is applicable at the target AP MLD.

In some embodiments, the TSF offset information may be transmitted using the similar SCS Info structure 490 as depicted in FIG. 4B. For example, each SCS Info field 490 includes a TSF offset value to be applied to the service start time for the SCS ID indicated in that SCS Info field.

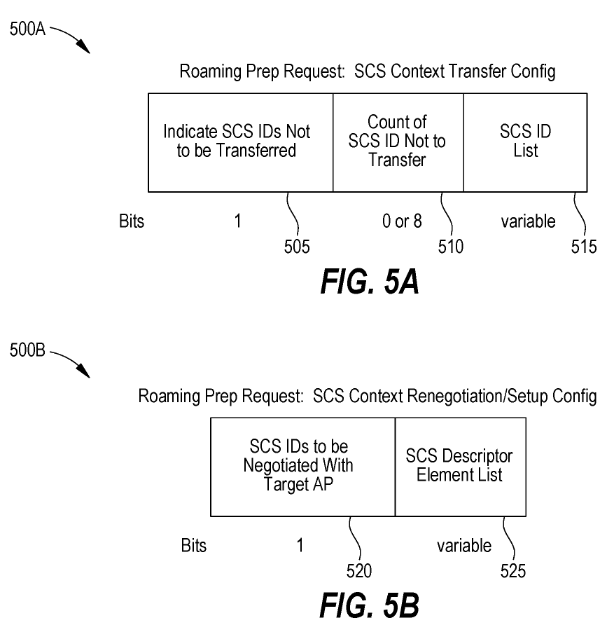

As discussed, in some embodiments, renegotiation of SCS parameters or negotiation (or setup) of new SCS streams with the target AP MLD is not permitted during the roaming procedure. In such cases, a STA MLD, by default, transfers context information for all active SCS streams to a target AP MLD during roaming preparation, and any renegotiation/negotiation of SCS parameters for one or more SCS streams is performed after roaming has been completed. In other embodiments, renegotiation and negotiation of SCS streams is desired (or permitted) as part of the roaming preparation procedure. In these embodiments, SCS context transfer configuration information is included within a roaming preparation request transmitted by the STA MLD to enable the target AP MLD to determine which SCS contexts are to be transferred without renegotiation and which SCS streams are subject to renegotiation or setup as part of roaming preparation. FIGS. 5A and 5B illustrate example configuration structures that may be included in such a roaming preparation request.

FIG. 5A depicts an example structure 500A of an SCS context transfer configuration information included within a roaming preparation request. The illustrated structure enables a STA MLD to indicate one or more SCS streams for which context information is not to be transferred to the target AP MLD during roaming preparation.

As depicted, the configuration information includes a first field 505, also referred to as the Indicate SCS IDs Not to be Transferred field, which may comprise a single bit. When set to a first value (e.g., “1”), the field 505 indicates that the roaming preparation request includes information identifying SCS streams for which context is not to be transferred to the target AP MLD. When set to a second value (e.g., “0”), the field 505 indicates that context information for all SCS streams is to be transferred (where renegotiation is not allowed or desired). In some embodiments, the field 505 may be optionally included.

The configuration information further includes a Count of SCS ID Not to Transfer field 510, which indicates the number of SCS IDs included in the SCS ID List field 515. The SCS ID List field 515 has a variable length corresponding to the value indicated by the count field 510 and identifies one or more SCS streams (based on SCS IDs) for which context information is excluded from transfer to the target AP MLD. The fields 510 and 515 may be included only when field 505 indicates the presence of information identifying SCS streams for which context is not to be transferred to the target AP MLD. In one embodiment, the field 510 is always included and is set to 0 if there are no SCS streams for which context information is excluded from transfer to the target AP MLD. The disclosed configuration enables selective exclusion of SCS contexts from transfer during roaming preparation. SCS streams identified as excluded from context transfer may then be treated by the target AP MLD as SCS streams that require renegotiation or new SCS stream setup. In some embodiments, instead of indicating SCS streams to be excluded from transfer, the STA MLD may explicitly indicate SCS streams for which SCS renegotiation or new SCS stream negotiation or setup is requested as part of roaming preparation.

FIG. 5B depicts an example structure 500B of an SCS context renegotiation or setup configuration information that is included within a roaming preparation request to explicitly identify one or more SCS streams to be negotiated with the target AP MLD.

As depicted, the configuration includes an SCS IDs to be Negotiated with Target AP field 520, which comprises a single bit indicating whether the roaming preparation request includes SCS streams to be renegotiated or newly set up with the target AP MLD. When set to a first value (e.g., “1”), the field 520 indicates that renegotiation or setup is requested for one or more SCS streams.

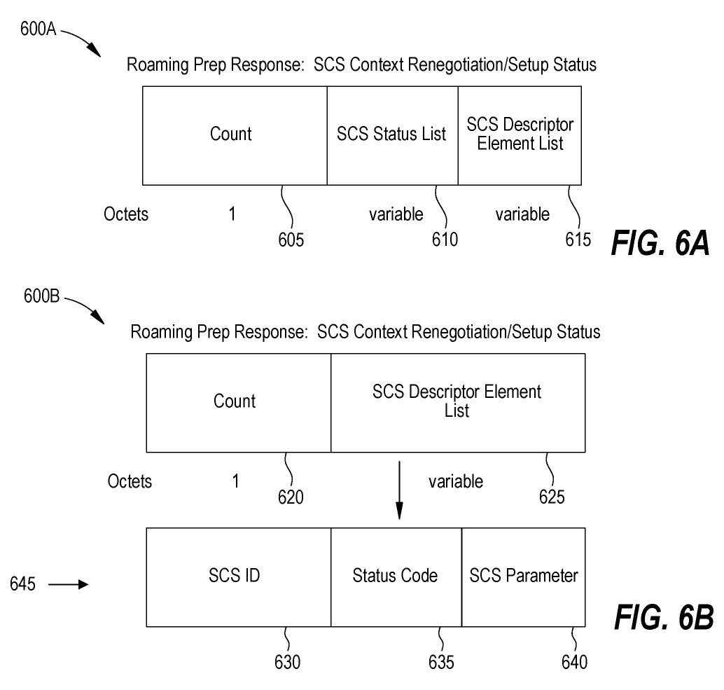

The configuration further includes an SCS Description Element List field 525, which has a variable length and includes one or more SCS descriptor elements. Each SCS descriptor element may define parameters associated with an SCS stream to be renegotiated or a new SCS stream to be negotiated/set up at the target AP MLD, such as traffic characteristics, resource requirements, or other SCS-related attributes and parameters. The target AP MLD processes the SCS descriptor elements during roaming preparation to determine whether requested SCS renegotiation or new SCS stream setup can be supported. Based on this determination, SCS renegotiation or setup status information is provided in the roaming preparation response back to the STA MLD. FIGS. 6A and 6B illustrate example structures that may be used to convey such SCS context renegotiation or setup status information.

FIG. 6A depicts an example structure 600A of an SCS context renegotiation or setup status information included within a roaming preparation response on a per-SCS stream basis.

As shown, the example structure includes a Count field 605, which indicates the number of SCS streams for which renegotiation or setup status information is provided. The structure further includes an SCS Status List field 610, which has a variable length and provides status information (e.g., accept or reject status) for respective SCS streams (identified by the SCS ID) indicated in the roaming preparation request. The SCS status information may include, for example, whether SCS renegotiation or SCS setup of each SCS stream has been accepted or rejected by the target AP MLD. The SCS Status List includes a list of SCS IDs and corresponding status information.

In addition, the structure includes an SCS Descriptor Element List field 615, which has a variable length and may include one or more SCS descriptor elements corresponding to SCS streams for which renegotiation or setup was not accepted. The SCS descriptor elements in the list field may include suggested parameters or modified traffic characteristics proposed by the target AP MLD for the rejected SCS streams.

FIG. 6B depicts an example structure 600B of an SCS context renegotiation or setup status information included within a roaming preparation response. The illustrated structure provides SCS status information on a per-SCS basis as part of the SCS Descriptor element (e.g., by including a Status Code field for each SCS ID).

As depicted, the structure includes a Count field 620, which indicates the number of SCS streams for which SCS status information is included. The structure further includes an SCS Descriptor Element List field 625, which has a variable length corresponding to the value indicated by the Count field 620. The SCS Descriptor Element List field 625 comprises one or more SCS Descriptor elements 645, which include a status code field corresponding to a respective SCS stream identified by the SCS ID.

Each SCS Descriptor element 645 includes an SCS ID field 630, which identifies the SCS stream for which the status information is provided, a Status Code field 635, which indicates a result of SCS renegotiation or setup for the identified SCS stream (e.g., accepted or rejected status), and an SCS Parameter field 640, which may include one or more parameters associated with the SCS stream (e.g., in a QoS Characteristics element included in the SCS Descriptor element). The SCS Parameter field 640 may include, for example, modified configuration parameters or traffic characteristics proposed by the target AP MLD for the rejected SCS streams. The Status Code field 635 may be included as part of an SCS status subelement included in the SCS Descriptor element (e.g. in the Optional subelements field). In one embodiment, when a service start time is provided for the SCS stream, the response also includes an adjusted service start time for the SCS stream, which is adjusted based on a reference link of the target AP MLD that is also indicated in the response. The adjusted service start time and the service start time link ID information can be indicated in the SCS status subelement or another subelement (or fields) included in the SCS Descriptor element (not shown in FIG. 6B).

One or more SCS Descriptor element 645 may be included within the structure 600B to convey renegotiation or setup results for different SCS streams in a single roaming preparation response. Through the structure, the target AP MLD provides per-SCS status results indicating acceptance, rejection, or modified parameter information for each respective SCS stream.

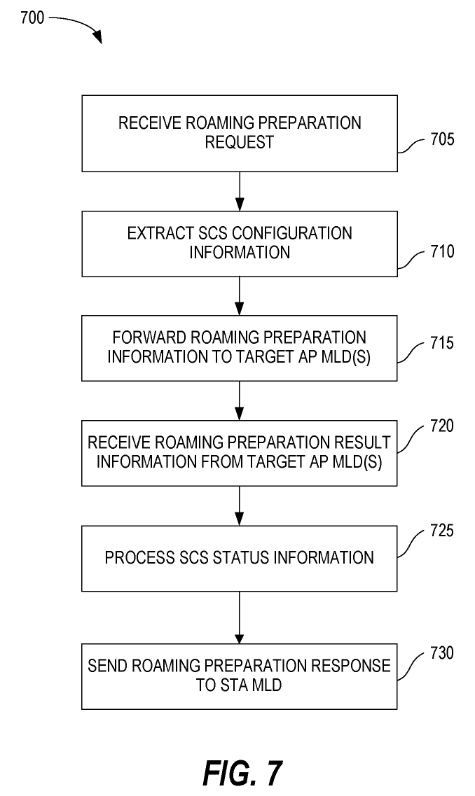

FIG. 7 depicts an example method 700 performed by a serving AP MLD for roaming preparation. The serving AP MLD (e.g., 210 in FIG. 2) is currently connected with a STA MLD (e.g., 205 in FIG. 2). The illustrated operations are performed prior to initiation of roaming transition and are intended to provide SCS streams related preparation information to enable seamless roaming of a STA MLD from the serving AP MLD to a target AP MLD.

At block 705, the serving AP MLD (e.g., 210 in FIG. 2) receives a roaming preparation request from a STA MLD (e.g., 205 in FIG. 2) connected to it. The roaming preparation request may include SCS resource reservation configuration information specifying one or more SCS streams for which prioritization of resource reservation is requested at the target AP MLD, as discussed with reference to FIG. 3. In embodiments where SCS streams renegotiation or new SCS streams negotiation or setup is desired (or allowed) during roaming preparation, the roaming request may further include SCS context transfer configuration information and SCS context renegotiation or setup configuration information, as discussed with reference to FIGS. 5A and 5B.

At block 710, the serving AP MLD extracts SCS-related configuration information from the roaming preparation request. This may include one or more of the SCS streams for which resource reservation is requested, SCS streams for which context is excluded from being transferred to the target AP MLD, and/or SCS streams for which SCS renegotiation or new SCS stream negotiation or setup is explicitly requested as part of roaming preparation.

At block 715, the serving AP forwards the roaming preparation information to one or more target AP MLDs (e.g., 215 in FIG. 2) within the same SMD. The information may be forwarded via an inter-AP signaling interface, and the serving AP MLD may preserve or change the structure and semantics of the received SCS-related configuration information from the STA MLD.

At block 720, the serving AP receives roaming preparation results from the target AP MLDs. The results may include SCS resource reservation status information, such as described with reference to FIGS. 4A and 4B, and SCS context renegotiation or setup status information, such as described with reference to FIGS. 6A and 6B.

At block 725, the serving AP MLD processes the received SCS status information and generates a roaming preparation response.

At block 730, the serving AP MLD sends the roaming preparation response to the STA MLD. The roaming preparation response may include SCS streams resource reservation status, SCS streams service start timing information, SCS streams renegotiation or negotiation (or setup) results, and any modified or suggested SCS parameters for corresponding SCS streams identified in the roaming preparation request, as discussed with reference to FIGS. 4A-4B and 6A-6B. Based on the response, the STA MLD can determine whether roaming can proceed and how SCS contexts, SCS stream resource reservations, and SCS stream renegotiations or negotiations are handled upon roaming. When SCS streams service start time information is provided in the response, the STA MLD may adjust the service start time for one or more SCS streams based on the received service start time or time offset information for the corresponding SCS stream.

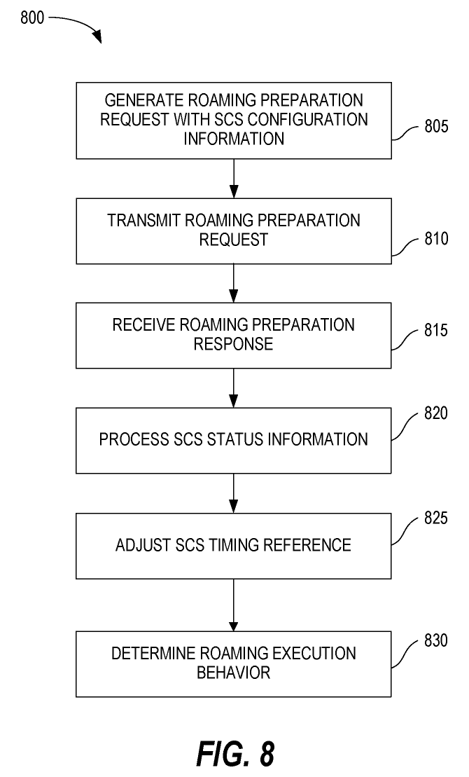

FIG. 8 depicts an example method 800 performed by a STA MLD for roaming reparation. The STA MLD (e.g., 205 in FIG. 2) is currently connected with a serving AP MLD (e.g., 210 in FIG. 2). The illustrated operations are performed prior to the initiation of roaming and are intended to enable coordination of SCS resource reservation and SCS stream renegotiation or negotiation (or setup) with a target AP MLD so that seamless roaming may be performed.

At block 805, the STA MLD generates a roaming preparation request that includes SCS configuration information. The roaming preparation request includes SCS resource reservation configuration information specifying one or more SCS streams for which prioritization of resource reservation is requested at the target AP MLD, as discussed with reference to FIG. 3. In embodiments where SCS stream renegotiation or new SCS steam negotiation or setup is desired (or permitted) during roaming preparation, the roaming preparation request further includes SCS context transfer configuration information and/or SCS context renegotiation or setup configuration information, as discussed with reference to FIGS. 5A and 5B.

At block 810, the STA MLD transmits the roaming preparation request to the serving AP MLD for forwarding to one or more candidate target AP MLDs. The roaming preparation request enables the target AP MLDs to evaluate resource reservation availability for SCS streams, SCS context handling, and potential SCS stream renegotiation or setup prior to roaming.

At block 815, the STA MLD receives a roaming preparation response sent by the serving AP MLD. The roaming preparation response may include SCS resource reservation status information, as discussed with reference to FIGS. 4A and 4B. In embodiments where SCS streams renegotiation or negotiation is desired (or allowed), SCS context renegotiation or setup status information may be included, such as described with reference to FIGS. 6A and 6B.

At block 820, the STA MLD processes SCS status information included in the roaming preparation response. The processing may include determining whether requested SCS stream resource reservations have been accepted, partially accepted, or rejected, and identifying SCS stream renegotiation or setup results for respective SCS streams when applicable.

At block 825, when service start timing information is provided for SCS streams in the roaming preparation response, the STA MLD adjusts the service start time for one or more SCS streams based on the received timing/TSF offset information for the SCS streams or based on the revised service start time for the SCS streams. The timing information may include a service start time or a relative time offset, and the STA MLD may compute adjusted service start times for respective SCS streams.

At block 830, the STA MLD determines roaming execution behavior based on the processed SCS status information. The determination may include deciding whether to proceed with roaming, or defer roaming, or find another candidate for roaming or maintain the existing connection with the serving AP MLD based on SCS resource availability, SCS renegotiation results, and QoS requirements.

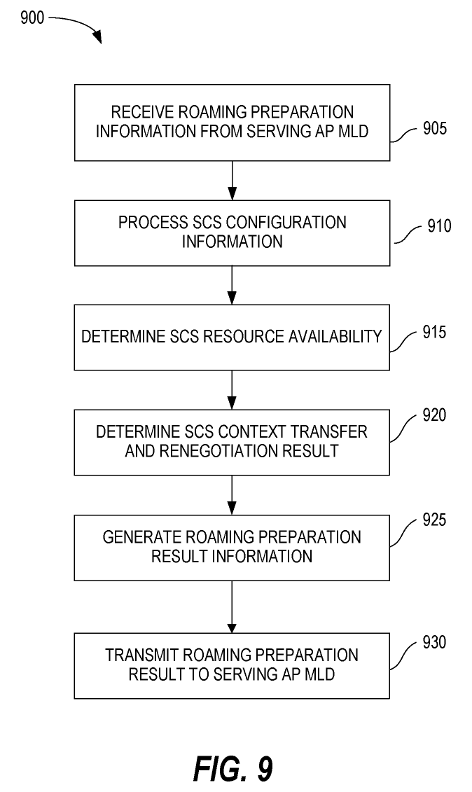

FIG. 9 depicts an example method 900 performed by a target AP MLD for roaming preparation. The illustrated operations are performed prior to the initiation of the roaming transition and are intended to enable coordination of SCS resource reservation and SCS stream renegotiation or negotiation with a target AP MLD so that seamless roaming may be performed. In some embodiments, the target AP MLD (e.g., AP MLD 2 or AP MLD 3 in FIG. 1) is one of multiple APs within the same SMD (e.g., 110-1 in FIG. 1) as a serving AP MLD (e.g., AP MLD 1 in FIG. 1) to which the STA MLD (e.g., STA MLD 1 in FIG. 1) is currently connected. The method 900 represents operations executed by the target AP MLD upon receiving roaming preparation information from the serving AP MLD.

At block 905, the target AP MLD receives roaming preparation information forwarded by the serving AP MLD. The roaming preparation information may be received via a backhaul connection or other inter-AP interface (e.g., wired control-plane interface, coordination channel, or network-based signaling interface between AP MLDs). The roaming preparation information may include SCS-related configuration data generated by the STA MLD and forwarded by the serving AP MLD.

At block 910, the target AP MLD processes SCS configuration information to determine which SCS streams are requested for prioritization of resource reservation at the target AP MLD. In embodiments where SCS stream renegotiation or SCS stream negotiation is desired (or permitted) during roaming preparation, the target AP MLD further determines which SCS streams are identified for SCS stream renegotiation or SCS stream negotiation/setup and identifies any proposed SCS parameters associated with the requested SCS renegotiation/negotiation.

At block 915, the target AP MLD determines SCS resource availability based on the processed SCS configuration information. The determination may include evaluating the availability of radio resources, scheduling capacity, and other link-specific or device-specific resources required to support requested SCS streams. In multi-link embodiments, the target AP MLD may perform the determination across multiple links to assess whether requested SCS streams can be supported across one or more links that are being added at the target AP MLD as part of roaming preparation.

At block 920, the target AP MLD determines SCS context transfer and SCS stream renegotiation/negotiation results. This may include determining which requested SCS stream resource reservations can be accepted, which SCS streams can be partially supported, and which SCS streams cannot be supported. In embodiments where SCS renegotiation or negotiation or setup is desired (or permitted) during roaming preparation, the target AP MLD further determines whether requested SCS renegotiation or SCS negotiation or setup can be supported and, in some embodiments, identifies modified SCS parameters to propose to the STA MLD.

At block 925, the target AP MLD generates roaming preparation result information based on the determination. The roaming preparation result information may include a reply to the requested SCS resource reservation, including reservation status and associated service start timing information (e.g., a service start time or a TSF offset) for SCS streams. In embodiments involving SCS streams renegotiation or negotiation or setup, the target AP MLD may further indicate renegotiation or setup status for respective SCS streams and, for SCS streams that are not accepted, may include suggested modified parameters or configuration information.

At block 930, the target AP MLD transmits the roaming preparation result information to the serving AP MLD via the inter-AP interface. The serving AP MLD then forwards the information to the STA MLD using a roaming preparation response sent by the serving AP MLD to the STA MLD. The signaling response allows the STA MLD to determine whether and how to proceed with roaming and to perform any desired (or required) timing alignment or configuration adjustments prior to completing the roaming procedure.

FIGS. 7-9 illustrate the embodiments in which the STA MLD communicates roaming preparation information to a target AP MLD via a serving AP MLD. The illustrated embodiments are provided for conceptual clarity. In some embodiments, the STA MLD may communicate roaming requests and responses directly to a target AP MLD without involving the serving AP MLD. In other embodiments, roaming preparation requests and responses may be communicated through one or more additional entities within or outside of the same SMD, such as SMD-ME (e.g., 115-1 in FIG. 1), wireless controller, or other coordination node. In such configurations, the additional entity may receive roaming preparation requests from the STA MLD, forward relevant information to one or more candidate target AP MLDs, and relay roaming preparation responses back to the STA MLD or the serving AP MLD.

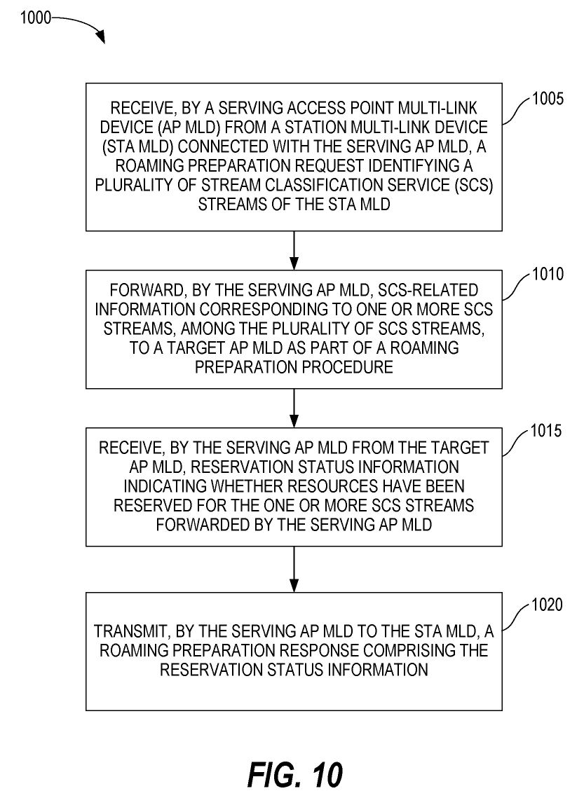

FIG. 10 is a block diagram depicting an example roaming preparation method 1000, according to some embodiments of the present disclosure.

At block 1005, a serving access point multi-link device (AP MLD) (e.g., AP MLD 1 in FIG. 1 or AP MLD 210 in FIG. 2) receives, from a station multi-link device (STA MLD) (e.g., STA MLD 1 in FIG. 1 or STA MLD 205 in FIG. 2) connected with the serving AP MLD, a roaming preparation request identifying a plurality of stream classification service (SCS) streams of the STA MLD (as depicted by step 1 in FIG. 2).

In some embodiments, the roaming preparation request comprises an indication (e.g., field 305 in FIG. 3) that roaming preparation with the target AP MLD is to be completed only if resources can be reserved for all of the one or more SCS streams forwarded by the serving AP MLD to the target AP MLD.

In some embodiments, the roaming preparation request comprises an indication of prioritization for resource reservation for the plurality of SCS streams at the target AP MLD, and the reservation status information is determined based at least in part on the indication of prioritization for resource reservation.

In some embodiments, the roaming preparation request comprises a first field (e.g., 315 in FIG. 3) indicating a count of stream classification service identifiers (SCS IDs) and a second field (e.g., 320 in FIG. 3) indicating a list of SCS IDs corresponding to the plurality of SCS streams of the STA MLD for which prioritization for resource reservation is requested at the target AP MLD.

In some embodiments, the roaming preparation request further comprises at least one of: a first field (e.g., 505 in FIG. 5A) comprising an indicator indicating whether one or more SCS streams are not to be transferred to the target AP MLD, a second field (e.g., 510 in FIG. 5A) comprising a count of SCS IDs not to be transferred, or a third field (e.g., 515 in FIG. 5A) comprising a list of SCS IDs corresponding to one or more SCS streams, among the plurality of SCS streams of the STA MLD, that are not to be transferred to the target AP MLD.

In some embodiments, the roaming preparation request further comprises an indicator (e.g., 520 in FIG. 5B) indicating whether one or more SCS streams are to be negotiated with the target AP MLD, and one or more SCS descriptor elements, each element corresponding to a respective SCS, among the plurality of SCS streams, to be negotiated with the target AP MLD.

In some embodiments, the one or more SCS streams to be renegotiated with the target AP MLD comprise one or more already setup SCS streams for which a different set of SCS parameters needs to be negotiated with the target AP MLD.

In some embodiments, the one or more SCS streams to be negotiated with the target AP MLD comprise one or more new SCS streams to be negotiated and setup with the target AP MLD.

At block 1010, the serving AP MLD forwards SCS-related information corresponding to one or more SCS streams, among the plurality of SCS streams, to a target AP MLD (e.g., AP MLD 2 or AP MLD 3 in FIG. 1 or AP MLD 215 in FIG. 2) as part of a roaming preparation procedure (as depicted by step 2 in FIG. 2).

At block 1015, the serving AP MLD receives, from the target AP MLD, reservation status information indicating whether resources have been reserved for the one or more SCS streams forwarded by the serving AP MLD (as depicted by step 3 in FIG. 2).

At block 1020, the serving AP MLD transmits, to the STA MLD, a roaming preparation response comprising the reservation status information (as depicted by step 4 in FIG. 2).

In some embodiments, the reservation status information in the roaming preparation response comprises one or more accepted SCS streams (e.g., within 435 in FIG. 4A or 450 in FIG. 4B) at the target AP MLD for which resources have been successfully reserved at the target AP MLD.

In some embodiments, the roaming preparation response comprises a first field (e.g., 410 in FIG. 4A) indicating that resources have been successfully reserved for all of the one or more SCS streams forwarded by the serving AP MLD to the target AP MLD.

In some embodiments, the roaming preparation response comprises a first field (e.g., 415 in FIG. 4A) identifying a Service Start Time Link identifier (ID), and a second field (e.g., 440 in FIG. 4A) identifying an adjusted Service Start Time for the each accepted SCS stream at the target AP MLD.

In some embodiments, the Service Start Time Link identifier (ID) indicates a reference link of the target AP MLD, and the reference link is used to adjust the Service Start Time for the each accepted SCS stream at the target AP MLD.

In some embodiments, the Service Start Time ID applies to all of the one or more accepted SCS streams at the target AP MLD.

In some embodiments, the roaming preparation response further comprises a first field (e.g., 610 in FIG. 6A or 635 in FIG. 6B) comprising status information indicating whether setup of each SCS stream identified for renegotiation or negotiation with the target AP MLD is accepted or rejected.

In some embodiments, in response to determining that the status information for at least one SCS stream is indicated as rejected, the roaming preparation response further comprises an SCS descriptor element (e.g., 615 in FIG. 6A or 645 in FIG. 6B) comprising one or more suggested parameters for the rejected SCS stream.

In some embodiments, in response to determining that the status information for at least one SCS stream is indicated as accepted, the roaming preparation response further comprises adjusted service start time and a service start time Link ID field for the accepted SCS stream.

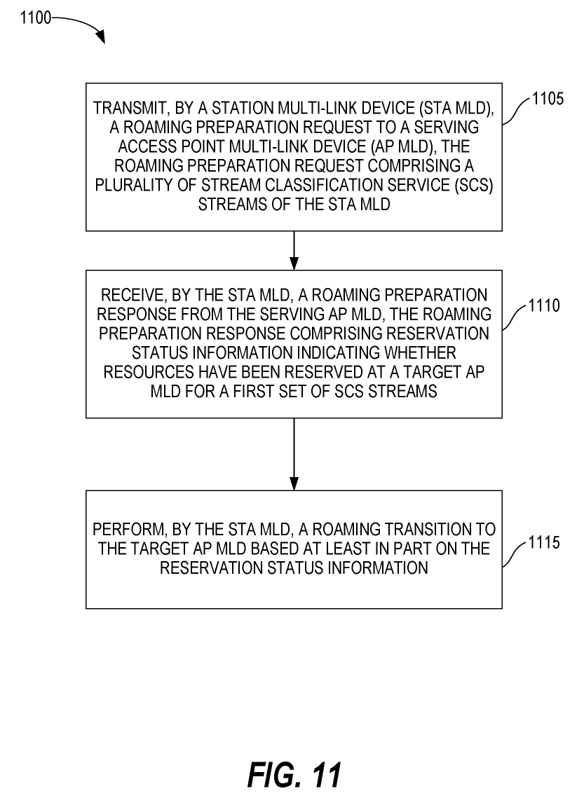

FIG. 11 is a block diagram depicting an example roaming preparation method, according to some embodiments of the present disclosure.

At block 1105, a STA MLD (e.g., STA MLD 1 in FIG. 1 or STA MLD 205 in FIG. 2) transmits a roaming preparation request to an access point multi-link device (AP MLD) (e.g., AP MLD 1 in FIG. 1 or AP MLD 210 in FIG. 2), the roaming preparation request comprising a plurality of stream classification service (SCS) streams of the STA MLD.

At block 1110, the STA MLD receives a roaming preparation response from the AP MLD, the roaming preparation response comprising reservation status information indicating whether resources have been reserved at a target AP MLD for a first set of SCS streams.

At block 1115, the STA MLD performs a roaming transition to the target AP MLD based at least in part on the reservation status information.

In some embodiments, the roaming preparation request further comprises one or more SCS descriptor elements corresponding to a second set of SCS streams to be negotiated or renegotiated with the target AP MLD.

In some embodiments, the roaming preparation response further comprises status information indicating whether negotiation or renegotiation of each of the one or more SCS streams is accepted or rejected by the target AP MLD.

In some embodiments, the operation of performing the roaming transition comprises, in response to determining that at least one of the second set of SCS streams requested for negotiation or renegotiation was accepted, performing the roaming transition based on one or more newly established SCS parameters corresponding to the accepted SCS stream.

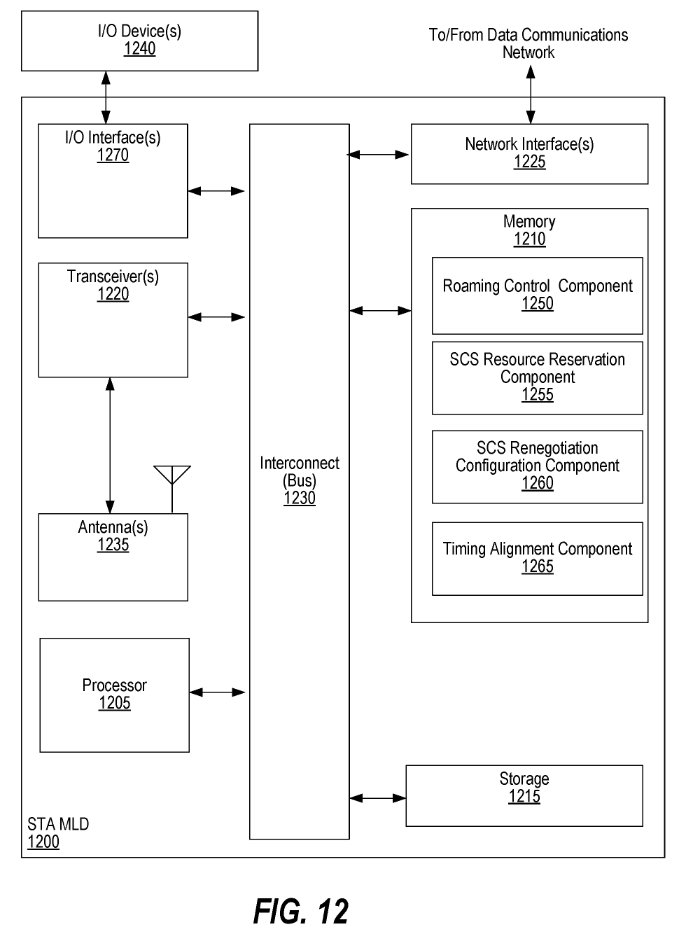

FIG. 12 depicts an example STA MLD 1200 configured to perform various aspects of the present disclosure, according to some embodiments of the present disclosure. The STA MLD 1200 may correspond to STA MLD (125-1) as depicted in FIG. 1 or STA MLD 205 as depicted in FIG. 2.

As illustrated, the STA MLD 1200 includes a processor 1205, memory 1210, storage 1215, one or more transceivers 1220, one or more I/O interfaces 1290, and one or more network interfaces 1225. In some embodiments, I/O devices 1240 are connected via the I/O interface(s) 1280. Further, via the network interface 1225, the STA MLD 1200 can be communicatively coupled with one or more other devices and components (e.g., via a network, which may include the Internet, local network(s), and the like). Each of the components is communicatively coupled by one or more buses 1230. In some embodiments, one or more antennas 1235 may be coupled to the transceivers 1220 for transmitting and receiving wireless signals.

The processor 1205 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1205 processes information received through the transceivers 1220, I/O interfaces 1290, and the network interfaces 1225. The processor 1205 retrieves and executes programming instructions stored in memory 1210, as well as stores and retrieves application data residing in storage 1215.

The storage 1215 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1215 may store a variety of data for the efficient functioning of the system.

The memory 1210 may include random access memory (RAM) and read-only memory (ROM). The memory 1210 may store processor-executable software code containing instructions that, when executed by the processor 1205, enable the ST A MLD 1200 to perform various functions described herein for wireless communication.

As depicted, the memory 1210 includes a roaming control component 1250, an SCS resource reservation component 1255, an SCS renegotiation configuration component 1260, and a timing alignment component 1265.

In one embodiment, the roaming control component 1250 is configured to determine whether roaming is to be performed and to initiate a roaming preparation procedure prior to roaming execution. The roaming control component 1250 generates roaming preparation requests, transmits the requests via the transceivers 1220, and processes roaming preparation responses received from a serving AP MLD, one or more target AP MLDs, or any other entity within the same SMD.

In one embodiment, the SCS resource reservation component 1255 is configured to determine which SCS streams are to be requested for resource reservation during roaming preparation. The SCS resource reservation component 1255 generates SCS resource reservation configuration information and, based on roaming preparation responses, determines which SCS resources have been accepted or reserved by the target AP MLD.

In one embodiment, the SCS renegotiation configuration component 1260 is configured to determine which SCS streams are to be renegotiated or set up as part of roaming preparation when renegotiation is allowed. The SCS renegotiation configuration component 1260 processes renegotiation or setup status information received from the target AP MLD and determines results for respective SCS streams, including acceptance, rejection, or modified parameter proposals.

In one embodiment, the timing alignment component 1265 is configured to process service start timing information received in roaming preparation responses. The timing alignment component 1265 adjusts timing references for one or more SCS streams based on an indicated service start time or a relative time offset to align activation of SCS resources with the target AP MLD.

Although depicted as a discrete component for conceptual clarity, in some embodiments, the operations of the depicted components (and others not illustrated) may be combined or distributed across any number of components. Further, although depicted as software residing in memory 1210, in some embodiments, the operations of the depicted components (and others not illustrated) may be implemented using hardware, software, or a combination of hardware and software.

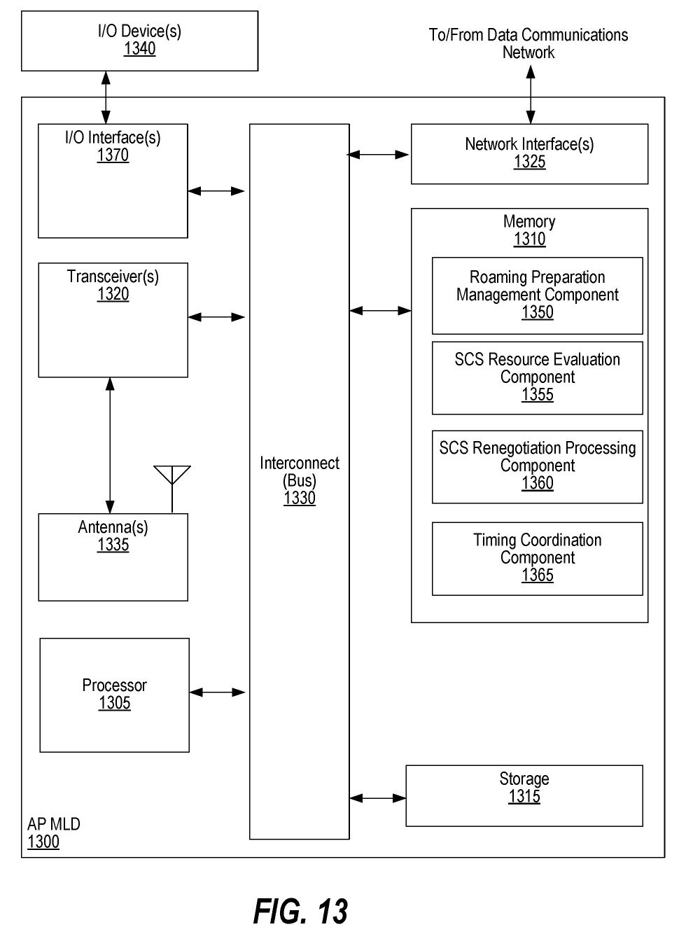

FIG. 13 depicts an example AP MLD 1300 configured to perform various aspects of the present disclosure, according to some embodiments of the present disclosure. The example AP MLD 1300 may correspond to a serving AP MLD, such as the AP MLD 1 (120-1) as depicted in FIG. 1 or the AP MLD 210 in FIG. 2, or a target AP MLD, such as the AP MLD 2 (120-2) or AP MLD 3 (120-2) in FIG. 1 or the AP MLD 215 in FIG. 2.

As illustrated, the AP MLD 1300 includes a processor 1305, memory 1310, storage 1315, one or more transceivers 1320, one or more I/O interfaces 1390, and one or more network interfaces 1325. In some embodiments, I/O devices 1340 are connected via the I/O interface(s) 1380. Further, via the network interface 1325, the AP MLD 1300 can be communicatively coupled with one or more other devices and components (e.g., via a network, which may include the Internet, local network(s), and the like). Each of the components is communicatively coupled by one or more buses 1330. In some embodiments, one or more antennas 1335 may be coupled to the transceivers 1320 for transmitting and receiving wireless signals.

The processor 1305 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1305 processes information received through the transceivers 1320, I/O interfaces 1390, and the network interfaces 1325. The processor 1305 retrieves and executes programming instructions stored in memory 1310, as well as stores and retrieves application data residing in storage 1315.

The storage 1315 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1315 may store a variety of data for the efficient functioning of the system.

The memory 1310 may include random access memory (RAM) and read-only memory (ROM). The memory 1310 may store processor-executable software code containing instructions that, when executed by the processor 1305, enable the AP MLD 1300 to perform various functions described herein for wireless communication.

As depicted, the memory 1310 includes a roaming preparation management component 1350, an SCS resource evaluation component 1355, an SCS renegotiation processing component 1360, and a timing coordination component 1365.

In one embodiment, the roaming preparation management component 1350 is configured to receive, process, and forward roaming preparation requests and responses. When operating as a serving AP MLD, the roaming preparation management component 1350 forwards roaming preparation requests received from a STA MLD to a target AP MLD and forwards roaming preparation responses back to the STA MLD. When operating as a target AP MLD, the roaming preparation management component 1350 receives roaming preparation requests and initiates evaluation of SCS resource availability and context handling.

In one embodiment, the SCS resource evaluation component 1355 is configured to determine availability of resources for requested SCS streams. The SCS resource evaluation component 1355 evaluates radio resources, scheduling capacity, and link-specific or device-specific limitations and determines whether requested SCS resource reservations can be supported.

In one embodiment, the SCS renegotiation processing component 1360 is configured to process SCS renegotiation or setup configuration information included in roaming preparation requests. The SCS renegotiation processing component 1360 determines whether requested renegotiation or setup parameters can be supported and identifies modified parameters when requested SCS streams cannot be supported as specified.

In one embodiment, the timing coordination component 1365 is configured to determine service start timing information associated with accepted SCS streams. The timing coordination component 1365 determines the service start time or relative timing offset and associates timing information with corresponding links and SCS streams.

Although depicted as a discrete component for conceptual clarity, in some embodiments, the operations of the depicted components (and others not illustrated) may be combined or distributed across any number of components. Further, although depicted as software residing in memory 1310, in some embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, by a serving access point multi-link device (AP MLD) from a station multi-link device (STA MLD) connected with the serving AP MLD, a roaming preparation request identifying a plurality of stream classification service (SCS) streams of the STA MLD;
forwarding, by the serving AP MLD, SCS-related information corresponding to one or more SCS streams, among the plurality of SCS streams, to a target AP MLD as part of a roaming preparation procedure;
receiving, by the serving AP MLD from the target AP MLD, reservation status information indicating whether resources have been reserved for the one or more SCS streams forwarded by the serving AP MLD; and
transmitting, by the serving AP MLD to the STA MLD, a roaming preparation response comprising the reservation status information.

2. The method of claim 1, wherein the roaming preparation request comprises an indication that roaming preparation with the target AP MLD is to be completed only if resources can be reserved for all of the one or more SCS streams forwarded by the serving AP MLD to the target AP MLD.

3. The method of claim 1, wherein the roaming preparation request comprises an indication of prioritization for resource reservation for the plurality of SCS streams at the target AP MLD, and wherein the reservation status information is determined based at least in part on the indication of prioritization for resource reservation.

4. The method of claim 1, wherein the roaming preparation request comprises a first field indicating a count of stream classification service identifiers (SCS IDs) and a second field indicating a list of SCS IDs corresponding to the plurality of SCS streams of the STA MLD for which prioritization for resource reservation is requested at the target AP MLD.

5. The method of claim 1, wherein the reservation status information in the roaming preparation response comprises one or more accepted SCS streams, among the plurality of SCS streams, at the target AP MLD for which resources have been reserved at the target AP MLD.

6. The method of claim 1, wherein the roaming preparation response comprises a first field indicating that resources have been reserved for all of the one or more SCS streams forwarded by the serving AP MLD to the target AP MLD.

7. The method of claim 5, wherein the roaming preparation response comprises a first field identifying a Service Start Time Link identifier (ID), and a second field identifying an adjusted Service Start Time for the each accepted SCS stream at the target AP MLD.

8. The method of claim 7, wherein the Service Start Time Link identifier (ID) indicates a reference link of the target AP MLD, and the reference link is used to adjust the Service Start Time for the each accepted SCS stream at the target AP MLD.

9. The method of claim 8, wherein the Service Start Time Link ID applies to all of the one or more accepted SCS streams at the target AP MLD.

10. The method of claim 1, wherein the roaming preparation request further comprises at least one of:
a first field comprising an indicator indicating whether one or more SCS streams are not to be transferred to the target AP MLD,
a second field comprising a count of SCS IDs not to be transferred, or
a third field comprising a list of SCS IDs corresponding to one or more SCS streams, among the plurality of SCS streams of the STA MLD, that are not to be transferred to the target AP MLD.

11. The method of claim 1, wherein the roaming preparation request further comprises:
an indicator indicating whether one or more SCS streams are to be renegotiated or negotiated with the target AP MLD, and
one or more SCS descriptor elements, each element corresponding to a respective SCS stream, that is to be renegotiated or negotiated with the target AP MLD.

12. The method of claim 11, wherein the one or more SCS streams to be renegotiated with the target AP MLD comprise one or more already setup SCS streams for which a different set of SCS parameters needs to be negotiated with the target AP MLD.

13. The method of claim 11, wherein the one or more SCS streams to be negotiated with the target AP MLD comprise one or more new SCS streams to be negotiated and setup with the target AP MLD.

14. The method of claim 11, wherein the roaming preparation response further comprises a first field comprising status information indicating whether setup of each SCS stream identified for renegotiation or negotiation with the target AP MLD is accepted or rejected.

15. The method of claim 14, wherein in response to determining that the status information for at least one SCS stream is indicated as rejected, the roaming preparation response further comprises an SCS descriptor element comprising one or more suggested parameters for the rejected SCS stream.

16. The method of claim 14, wherein, in response to determining that the status information for at least one SCS stream is indicated as accepted, the roaming preparation response further comprises providing an adjusted service start time and a service start time Link ID field for the accepted SCS stream.

17. A system of an access point (AP), comprising:
one or more computer processors; and
one or more memories collectively containing one or more programs, which, when executed by the one or more computer processors, perform an operation, the operation comprising:
receiving, by a serving access point multi-link device (AP MLD) from a station multi-link device (STA MLD) connected with the serving AP MLD, a roaming preparation request identifying a plurality of stream classification service (SCS) streams of the STA MLD;
forwarding, by the serving AP MLD, SCS-related information corresponding to one or more SCS streams, among the plurality of SCS streams, to a target AP MLD as part of a roaming preparation procedure;
receiving, by the serving AP MLD from the target AP MLD, reservation status information indicating whether resources have been reserved for the one or more SCS streams forwarded by the serving AP MLD; and
transmitting, by the serving AP MLD to the STA MLD, a roaming preparation response comprising the reservation status information.

18. The system of claim 17, wherein the roaming preparation request comprises an indication that roaming preparation with the target AP MLD is to be completed only if resources can be reserved for all of the one or more SCS streams forwarded by the serving AP MLD to the target AP MLD.

19. The system of claim 17, wherein the roaming preparation request comprises an indication of prioritization for resource reservation for the plurality of SCS streams at the target AP MLD, and wherein the reservation status information is determined based at least in part on the indication of prioritization for resource reservation.

20. A method, comprising:
transmitting, by a station multi-link device (STA MLD), a roaming preparation request to a serving access point multi-link device (AP MLD), the roaming preparation request comprising a plurality of stream classification service (SCS) streams of the STA MLD;
receiving, by the STA MLD, a roaming preparation response from the serving AP MLD, the roaming preparation response comprising reservation status information indicating whether resources have been reserved at a target AP MLD for a first set of SCS streams; and
performing, by the STA MLD, a roaming transition to the target AP MLD based at least in part on the reservation status information.

21. The method of claim 20, wherein the roaming preparation request further comprises one or more SCS descriptor elements corresponding to a second set of SCS streams to be negotiated or renegotiated with the target AP MLD.

22. The method of claim 21, wherein the roaming preparation response further comprises status information indicating whether negotiation or renegotiation of each of the second set of SCS streams is accepted or rejected by the target AP MLD.

23. The method of claim 22, wherein performing the roaming transition comprises, in response to determining that at least one of the second set of SCS streams requested for negotiation or renegotiation was accepted, performing the roaming transition based on one or more newly established SCS parameters corresponding to the accepted SCS stream.
